(19) United States
(12) Patent Application Publication
(10) Pub. No.: US 2020/0379409 A1
(43) Pub. Date: Dec. 3, 2020

(54) PROTECTIVE DEVICE FOR WRISTWATCHES AND THE LIKE

(71) Applicant: Clinton ERLANK, Durban (ZA)

(72) Inventor: Clinton ERLANK, Durban (ZA)

(21) Appl. No.: 16/427,687

(22) Filed: May 31, 2019

(51) Int. Cl. G04B 37/00; G04B 37/22

(52) U.S. Cl. CPC G04B 37/0008; G04B 37/1486; G04B 37/22

(57) ABSTRACT

The invention relates to a protective device that fits over a wristwatch or another instrument having a face comprising (i) a band for encircling the wrist of a user with an opening through which the face of the wristwatch or other instrument is visible, and (ii) a protective cover, wherein the direction of fastening the protective device around the wrist of the user and the direction of fastening the protective cover to the band of the device is in opposite directions, thereby ensuring that the opening in the protective device is centred over the face of the wristwatch or other instrument. The invention further relates to a method of protecting a wristwatch or another instrument having a face with the use of the protective device of the invention.

### FIELD OF THE INVENTION

The invention relates to a protective device that fits over a wristwatch or other instrument that is worn around the wrist of a user.

### BACKGROUND OF THE INVENTION

Many wristwatches and other instruments, such as biometric devices like those used for fitness-tracking, or medical analysis or diagnosis that may be worn on the wrist of a user, are expensive and susceptible to damage, particularly during sporting or other types of physical activities.

There are a number of protective devices that can be worn to protect the wristwatch or other instrument that are known, although these devices have various disadvantages or problems. For example, many of these protective devices require the wristwatch to be inserted into the device, and then the device to be applied to the arm of the wearer such as in the case of U.S. Pat. Nos. 7,252,215, 4,103,808, or 4,155,219. It would be far preferable for a protective device to be able to be simply fitted over a wristwatch or other instrument that is already being worn on the wrist. This could also be easily removed, as and when the user wishes, without also having to remove the protective device containing the wristwatch or other instrument from the wrist, remove the wristwatch or other instrument from the protective device and then fix the wristwatch or other instrument to the wrist again.

There are some protective devices that fit over a wristwatch worn on the wrist of a user, but typically these have a fairly complex methods of fitting over the watch face. For example, the user has to manoeuvre the watch face through a narrow aperture in the band of the protective device that fits around the wrist of the user so that the watch face lies over the band and can be seen. Alternatively the user has to slot two narrow strips of material under each side of the face of the watch and connect these to the band of the protective device so that the watch face is held in position in the device and can be seen. Examples of such devices are provided in U.S. Pat. Nos. 6,799,887 and 5,332,135.

Typically, the protective devices known in the art use a wristband strap comprising two bands having complimentary hook and loop fastening structures, such as Velcro®. The two bands overlap, thereby encircling the wrist and watch of the user within the protective device and the device is fastened by sticking the complimentary hook and loop fastening structures to each other. Examples of such devices are provided in U.S. Pat. Nos. 6,799,887 and 5,332,135. However, with such a fastening mechanism it is difficult to fasten the strap of the device and ensure that the watch face is centred within the aperture of the protective device, so that it can be viewed, particularly if this is to be done quickly and with only one hand. In particular, when centring these devices over the watch face, the watch face tends to move around the wrist with the band of the protective device, instead of the watch face staying put and the protective device opening positioning around the watch face.

Therefore, an alternative protective cover for a wristwatch or similar device which is simple to affix over the wristwatch or similar device whilst on the arm of a user, or remove it, and that is simple to fasten to the wrist and centre over the face of the wristwatch or similar instrument would be useful, particularly if this was capable of being easily done using one hand.

### SUMMARY OF THE INVENTION

According to a first aspect of the invention there is provided a protective device that fits over a wristwatch or another instrument having a face comprising (i) a band for encircling the wrist of a user with an opening through which the face of the wristwatch or other instrument is visible, and (ii) a protective cover, wherein the direction of fastening the protective device around the wrist of the user and the direction of fastening the protective cover to the band of the device is in opposite directions, thereby ensuring that the opening in the protective device is centred over the face of the wristwatch or other instrument when fastened to the wrist of the user.

In particular, the protective device comprises:
a. a flat band of material sized to encircle the wrist of a user, the band comprising an inner and an outer surface, the inner surface being proximate to the user's wrist and the outer surface being distal to the user's wrist when in use;
   i. the band having first and second end portions and a third intermediate portion,
      1. wherein the first end portion terminates in a fastening means on the outer surface of the band, and the second end portion comprises a flat loop or defines an elongate aperture transverse to the length of the band, the loop or aperture having a width such that the first end portion can pass therethrough, and
      2. wherein the third intermediate portion comprises:
         a. a fastening section on the outer surface of the band for releasably fastening to the fastening means after the fastening means has been passed through the flat loop or elongate aperture of the second end portion and flapped backwards towards the fastening section by a user; and
         b. a body cut-out section adjacent to the second end portion, the body cut-out section defining a central opening sized to surround the face of the wristwatch or other instrument; and
b. a protective cover comprising an inner and outer surface, the inner surface being proximate to the face of the wristwatch or other instrument and the outer surface being distal to the face of the wristwatch or other instrument when in use, the protective cover having first and second end portions and an intermediate portion,
   i. wherein the first end portion is affixed or affixable to the outer surface of the flat band between the body cut-out section and the second end portion of the band, or is integrally formed with and continues from the second end portion of the flat band;
   ii. the second end portion terminates in a fastening means on the inner surface for releasably fastening to the fastening section of the third intermediate portion of the band by a user; and
   iii. the intermediate portion is sized to cover the face of the wristwatch or other instrument when positioned over the face of the wristwatch or other instrument by a user, thereby protecting it.

The fastening means and fastening section may comprise a complimentary hook and loop fastener such as Velcro®.

The flat band material may comprise an elasticated or non-elasticated material. The flat band material may be neoprene, plastic, rubber or leather or other materials known to those skilled in the art.

The body cut-out section may comprise a strip of rubber tape defining the edges of the aperture. The body cut-out section may be integrally formed with the intermediate portion of the band. Alternatively, the body cut-out section may be formed by affixing the second end portion of the band to the fastening section of the intermediate portion of the band with two strips of elongate material, thereby defining the central opening. It is to be appreciated that the body cut-out section is sized such that one size fits all dimensions of the face of a watch or other instrument.

The flat loop or elongate aperture of the second end portion may be comprised of stainless steel, plastic, rubber or other materials known to those skilled in the art. Preferably, the flat loop or elongate aperture of the second end portion is comprised of stainless steel or plastic.

According to a further aspect of the invention there is provided a method for protecting a wristwatch or another instrument having a face and a wristband on the wrist of a user by application of the protective device of the invention, comprising:

locating the protective device over the wristwatch or other instrument on the wrist of the user such that the inner surface of the flat band is proximate to the wrist of the user and the body cut-out section is positioned over the face of the wristwatch or other instrument;

passing the first end portion of the band through the flat loop or elongate aperture of the second end portion of the band such that the band encircles the wrist of the user and folding the first end portion of the band away from the elongate aperture in a first direction towards the fastening portion of the intermediate portion of the band;

pulling the fastening end of the first end portion in the first direction, and fastening the fastening end to the fastening section; and

pulling the second end portion fastening end of the protective cover over the face of the wristwatch or other instrument and towards the fastening section of the intermediate portion of the flat band in a second direction, opposite to the first direction, thereby orientating the body cut-out section over the face of the wristwatch or other instrument.

### BRIEF DESCRIPTION OF THE DRAWINGS

FIG. 1 a) shows an isometric view of the back of one embodiment of the protective device of the invention when in an open state and b) shows an isometric view of the front of one embodiment of the protective device of the invention when in an open state and prior to stitching or gluing the first end portion of the cover 30 to the second end portion of the flat band 16.

FIG. 2 shows an isometric view of one embodiment of the protective device of the invention when applied to the wrist and wristwatch of a user and orientated over the face of the wristwatch, where the protective device has not yet been fastened, and protective cover flap is in the open position;

FIG. 3 shows an isometric view from above of one embodiment of the protective device of the invention when applied to the wrist and wristwatch of a user where the device is orientated over the face of the wristwatch and is fastened around the user's wrist, but the protective cover flap is in the open position;

FIG. 4 shows an isometric view from the side of one embodiment of the protective device of the invention when applied to the wrist and wristwatch of a user where the device is orientated over the face of the wristwatch and is fastened around the user's wrist, but the protective cover flap is in the open position; and

FIG. 5 shows a photograph of one embodiment of the invention during application of the protective device to the wrist and wristwatch of a user illustrating the opposed strapping mechanism where the wrist strap of the protective device is strapped to the wrist of the user by inserting one end of the strap through a loop on the other end, and then pulling the inserted strap backwards in a first direction towards the wrist strap for fastening. Thereafter, the protective cover flap of the protective device is orientated over the face of the wristwatch by pulling the cover flap over the face of the wristwatch in a second direction, opposite the first direction and the cover flap is then also fastened to the wrist strap of the protective device.

FIG. 6 shows a graphical representation of the stitched protective device ready for use by a wearer according to one preferred embodiment of the invention.

### DETAILED DESCRIPTION OF THE PREFERRED EMBODIMENT(S)

The invention will now be described with reference to the accompanying illustrations, which should not be construed as limiting the scope of the invention in any way, but which should rather be viewed as providing preferred embodiments of the invention.

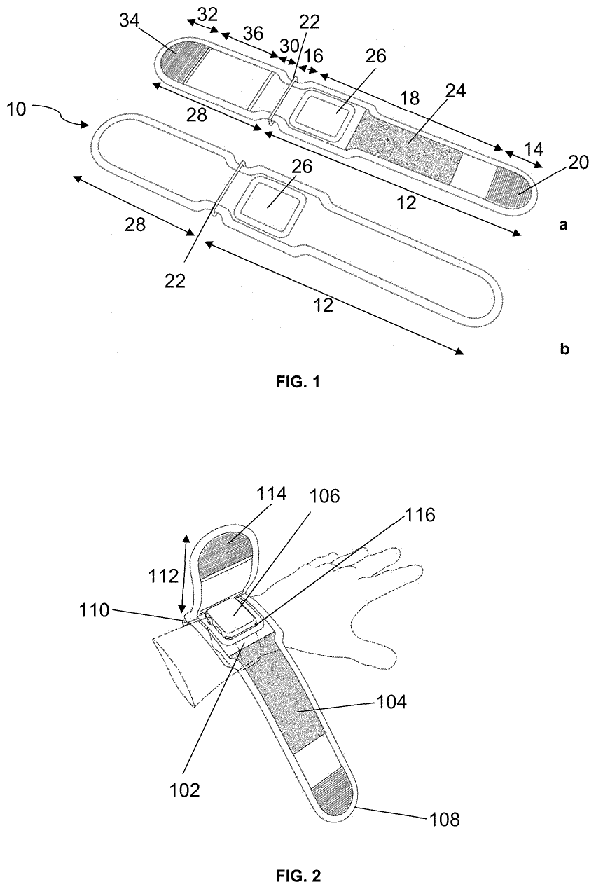

FIG. 1a shows the back view of an exemplary embodiment of the protective device of the invention when in the open position, before stitching or gluing, FIG. 1 b shows the front view of an exemplary embodiment of the protective device of the invention when in the open position, before stitching or gluing.

The protective device 10 generally comprises a flat band of material 12 that is of sufficient length to encircle the wrist of a user, the band 12 comprising an inner and an outer surface, the inner surface being proximate to the user's wrist and the outer surface being distal to the user's wrist when in use. The flat band 12 has a first 14 and second 16 end portion respectively on each end and a third intermediate portion 18 between the end portions.

The first end portion 14 terminates in a fastening means 20 on the outer surface of the band 12. The second end portion 16 comprises either a flat loop 22 or defines an elongate aperture (not shown) transverse to the length of the band 12. The loop 22 or aperture has a width such that the fastening means 20 can pass therethrough when the device is being fastened onto the wrist of the user. Preferably, the thickness of the fastening means 20 is such that it just clears the width of the loop 22 or the aperture, which provides a safety mechanism preventing the fastening means 20 of the protective device 10 from simply slipping through the loop 22 or aperture should it come unfastened.

The third intermediate portion 18 comprises a fastening section 24 on the outer surface of the band 12 that a user can fasten the fastening means 20 onto after passing the fastening means 20 through the flat loop 22 or elongate aperture of the second end portion 16 and pulling the fastening means 20 backwards in a first direction away from the flat loop 22 and towards the fastening section 24. Usually the fastening section 24 and fastening means 20 are made up of complimentary loop and hook fastening materials, like Velcro®. The intermediate portion 18 also comprises a body cut-out section 26 that is situated next to the second end portion 16 of the band 12. The body cut-out section 26 defines a central opening that is sized to surround the face (not shown) of a wristwatch or other instrument when in use.

In a preferred embodiment of the invention, the protective device also includes a protective cover 28 comprising a first 30 and second 32 end portion and an intermediate portion 36 therebetween. The intermediate portion 36 is comprised of an upper and a lower section, the lower section being proximate to the face of the watch or other instrument when in use and the upper section being distal thereto. The upper section is comprised of 2.5 mm breathable Neoprene® and the lower section is comprised of 2.5 mm texture rubber flexible Neoprene®.

The first end portion 30 is affixed or affixable to the outer surface of the flat band 12 between the body cut-out section 26 and the second end portion 16 of the band 12. The method of affixing might be by stitching, stapling or gluing the first end portion 30 to the outer surface of the flat band 12 adjacent the second end portion 16. Alternatively, the first end portion 30 might be integrally formed with the flat band 12, such that the second end portion 16 of the flat bank 12 continues to form the first end portion 30 of the protective cover 28.

The second end portion 32 terminates in a fastening means 34 on the inner surface for releasably fastening to the fastening section 24 of the third intermediate portion 18 of the band 12. As in the case with the fastening means 20 and fastening section 24 of the band 12, the fastening section and fastening means are typically made up of complimentary loop and hook fastening materials, like Velcro®.

The intermediate portion 36 of the protective cover 28 is sized to cover the face of the wristwatch or other instrument when in use, thereby protecting it.

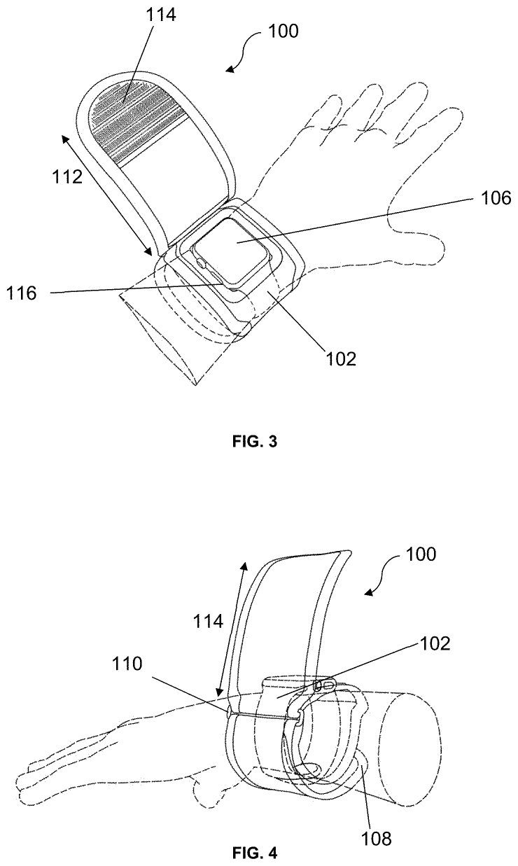

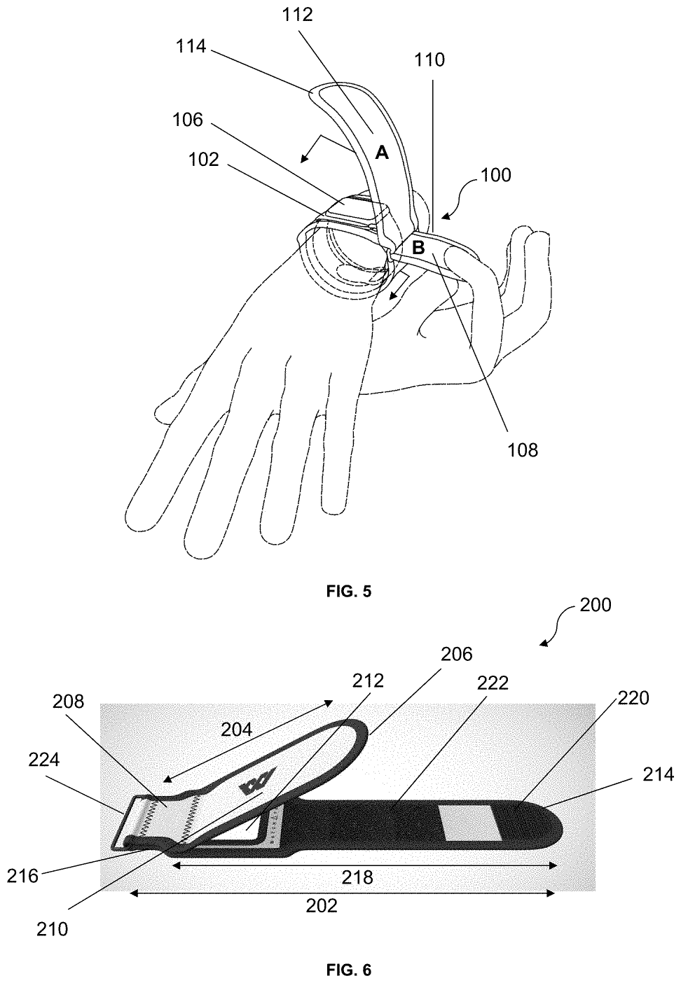

Referring to FIGS. 2 to 5, a method of protecting a wristwatch or other instrument on the arm of a user is described by fastening the protective device 100 of the invention over the wristwatch or other instrument.

This comprises locating the protective device 100 over the wristwatch 102 or other instrument on the wrist of the user such that the inner surface of the flat band is proximate to the wrist of the user and the body cut-out section is positioned over the face 106 of the wristwatch or other instrument. Thereafter, the first end portion 108 of the band is passed through the flat loop or elongate aperture 110 and folding it away from the elongate aperture 110 in a direction B towards the fastening section 104 of the intermediate portion of the band, whereafter the first end portion 108 of the band is fastened to the fastening section 104, thereby encircling the wrist and wristwatch 102 or other instrument of the user.

The next step is to close the protective cover 112 over the face 106 of the wristwatch. This is done by pulling the second end portion fastening end 114 of the protective cover 112 over the face 106 of the wristwatch or other instrument and towards the fastening section 104 of the intermediate portion of the flat band in a direction A, opposite to the direction B, thereby orientating the body cut-out section 116 over the face 106 of the wristwatch or other instrument and fastening the fastening end 114 of the protective cover 112 onto the fastening section 104 of the flat band.

FIG. 6 shows a graphical representation of the stitched protective device 200 ready for use by a wearer according to one preferred embodiment of the invention. The device comprises a band portion 202 and protective cover 204 portion, wherein the protective cover 204 comprises a first 206 and second 208 end portion and an intermediate portion 210 therebetween. The intermediate portion 210 is positioned over a body cut-out section 212 that is orientated over and surrounds the face of a watch or other instrument when fastened in use. The band portion comprises a first 214 and a second 216 end, and an intermediate section 218. The intermediate section 218 comprises a fastening means 220 adjacent the first end 214, a body cut-out section 212 adjacent the second end 216 for surrounding the face of a watch or other instrument of a user when in use and a fastening section 222 comprising a fastening means. The fastening means is typically Velcro®. The second end portion 208 of the protective cover is inserted through an elongated loop 224 and then folded back and stitched to the second end of the band portion 216 such that the protective cover 204 is orientated over and surrounds the face of a watch or other instrument when fastened in use.

I claim:

1. A protective device that fits over a wristwatch or another instrument having a face, comprising:
a band for encircling the wrist of a user comprising an opening through which the face of the wristwatch or other instrument is visible when in use and a fastening means; and
a protective cover and a fastening means,
configured such that when fastening the protective device around the wrist of the user, the direction of fastening the fastening means of the band of the protective device around the wrist of the user and the direction of fastening the fastening means of the protective cover to the band of the device are in opposite directions, thereby ensuring that the opening in the protective device is centred over the face of the wristwatch or other instrument.

2. The protective device according to claim 1, comprising:
a band of material sized to encircle the wrist of a user, the band comprising an inner and an outer surface, the inner surface being proximate to the user's wrist and the outer surface being distal to the user's wrist when in use, the band having first and second end portions and a third intermediate portion, wherein:
the first end portion terminates in a fastening means on the outer surface of the band;
the second end portion comprises a flat loop or defines an elongate aperture transverse to the length of the band, the loop or aperture having a width such that the first end portion can pass therethrough; and
the third intermediate portion comprises:
a fastening section on the outer surface of the band for releasably fastening to the fastening means after the fastening means has been passed through the flat loop or elongate aperture of the second end portion and flapped backwards towards the fastening section by a user; and
a body cut-out section adjacent to the second end portion, the body cut-out section defining a central opening sized to surround the face of the wristwatch or other instrument; and
a protective cover comprising an inner and outer surface, the inner surface being proximate to the face of the wristwatch or other instrument and the outer surface being distal to the face of the wristwatch or other instrument when in use, the protective cover having first and second end portions and an intermediate portion, wherein
the first end portion is affixed or affixable to the outer surface of the flat band between the body cut-out section and the second end portion of the band, or is integrally formed with and continues from the second end portion of the flat band;
the second end portion terminates in a fastening means on the inner surface for releasably fastening to the fastening section of the third intermediate portion of the band by a user; and
the intermediate portion is sized to cover the face of the wristwatch or other instrument when positioned over the face of the wristwatch or other instrument by a user, thereby protecting it.

3. The device according to claim 1, wherein the fastening means and fastening section comprise a complimentary hook and loop fastener.

4. The device according to claim 1, wherein the band material is comprised of an elasticated or non-elasticated material.

5. The device according to claim 1, wherein the band material is comprised of neoprene, plastic, rubber or leather.

6. The device according to claim 1, wherein the body cut-out section is integrally formed with the intermediate portion of the band.

7. The device according to claim 1, wherein the body cut-out section is formed by affixing the second end portion of the band to the fastening section of the intermediate portion of the band with two strips of elongate material, the two strips of material defining the central opening.

8. The device according to claim 7, wherein the two strips of material are comprised of neoprene, plastic, rubber or leather.

9. The device according to claim 1, wherein the flat loop or elongate aperture of the second end portion is comprised of stainless steel, plastic or rubber.

10. The device according to claim 1, wherein the flat loop or elongate aperture of the second end portion is comprised of stainless steel or plastic.

11. The device according to claim 1, configured to protect a wristwatch or another instrument having a face and a wristband on the wrist of a user by:
locating the protective device over the wristwatch or other instrument on the wrist of the user such that the inner surface of the flat band is proximate to the wrist of the user and the body cut-out section is positioned over the face of the wristwatch or other instrument;
passing the first end portion of the band through the flat loop or elongate aperture of the second end portion of the band such that the band encircles the wrist of the user and folding the first end portion of the band away from the elongate aperture in a first direction towards the fastening portion of the intermediate portion of the band;
pulling the fastening end of the first end portion in the first direction, and fastening the fastening end to the fastening section; and
pulling the second end portion fastening end of the protective cover over the face of the wristwatch or other instrument and towards the fastening section of the intermediate portion of the flat band in a second direction, opposite to the first direction, thereby orientating the body cut-out section over the face of the wristwatch or other instrument.

12. A method for protecting a wristwatch or another instrument having a face and a wristband on the wrist of a user by application of the protective device according to claim 1, comprising:
locating the protective device over the wristwatch or other instrument on the wrist of the user such that the inner surface of the flat band is proximate to the wrist of the user and the body cut-out section is positioned over the face of the wristwatch or other instrument;
passing the first end portion of the band through the flat loop or elongate aperture of the second end portion of the band such that the band encircles the wrist of the user and folding the first end portion of the band away from the elongate aperture in a first direction towards the fastening portion of the intermediate portion of the band;
pulling the fastening end of the first end portion in the first direction, and fastening the fastening end to the fastening section; and
pulling the second end portion fastening end of the protective cover over the face of the wristwatch or other instrument and towards the fastening section of the intermediate portion of the flat band in a second direction, opposite to the first direction, thereby orientating the body cut-out section over the face of the wristwatch or other instrument.
